(19) United States
(12) Patent Application Publication
(10) Pub. No.: US 2016/0207500 A1
(43) Pub. Date: Jul. 21, 2016

(54) METHODS AND SYSTEMS FOR MONITORING WIPER BLADES

(71) Applicant: GM GLOBAL TECHNOLOGY OPERATIONS LLC, Detroit, MI (US)

(72) Inventors: DAVID T. RENKE, MACOMB, MI (US); JAMES D. SAHLANEY, EASTPOINTE, MI (US)

(21) Appl. No.: 14/599,774

(22) Filed: Jan. 19, 2015

(51) Int. Cl. B60S 1/38; G01M 99/00

(52) U.S. Cl. CPC B60S 1/38; G01M 99/008; B60S 2001/3844

(57) ABSTRACT

Methods and systems are provided for monitoring a wiper blade. A method includes: determining at least one use factor; computing a use life based on the at least one use factor; and selectively generating notification data based on the use life.

### TECHNICAL FIELD

The present disclosure generally relates to vehicles, and more particularly relates to methods and systems for monitoring a wiper blade of a vehicle.

### BACKGROUND

A wiper blade is a device used to remove rain and debris from a windscreen or windshield. Almost all vehicles, including trains, watercraft and some aircraft, are equipped with such wipers. A wiper blade generally includes an arm that is pivotally attached to the vehicle at one end and that has blade attached to the other end. The arm is controlled to pivot back and forth at varying rates to cause the blade to swing back and forth over the glass. The blade moves along the surface of the windshield in order to push water from its surface.

Due to the frequent movement of the blade and the exposure to ambient conditions, the blade has a certain life expectancy. After the blade has reached the life expectancy, the blade may become ineffective and in some cases may cause damage to the glass.

Accordingly, it is desirable to provide methods and system for monitoring wiper blades of a vehicle. It is further desirable to provide methods and systems predicting a use life of the wiper blades and reporting the use life to a user of the vehicle. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for monitoring a wiper blade. A method includes: determining at least one use factor; computing a use life based on the at least one use factor; and selectively generating notification data based on the use life.

In one embodiment, a vehicle includes a wiper blade and a control module. The control module determines at least one use factor, computes a use life based on the at least one use factor, and selectively generates notification data based on the use life.

### DESCRIPTION OF THE DRAWINGS

The present disclosure will hereinafter be described in conjunction with the following drawing figures, wherein like numerals denote like elements, and:

FIG. 1 is an illustration of a part of a vehicle that includes, among other features, a wiper blade monitoring system in accordance with various exemplary embodiments;

FIG. 2 is a functional block diagram of the wiper blade monitoring system in accordance with various exemplary embodiments;

FIG. 3 is a data flow diagram of a control module of the wiper blade monitoring system in accordance with various exemplary embodiments; and

FIG. 4 is a flowchart of a method for monitoring a wiper blade of a vehicle in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to an application specific integrated circuit (ASIC), an electronic circuit, a processor (shared, dedicated, or group) and/or memory that executes or stores one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, exemplary embodiments may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that exemplary embodiments may be practiced in conjunction with any number of control systems, and that the vehicle systems described herein are merely exemplary embodiments.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

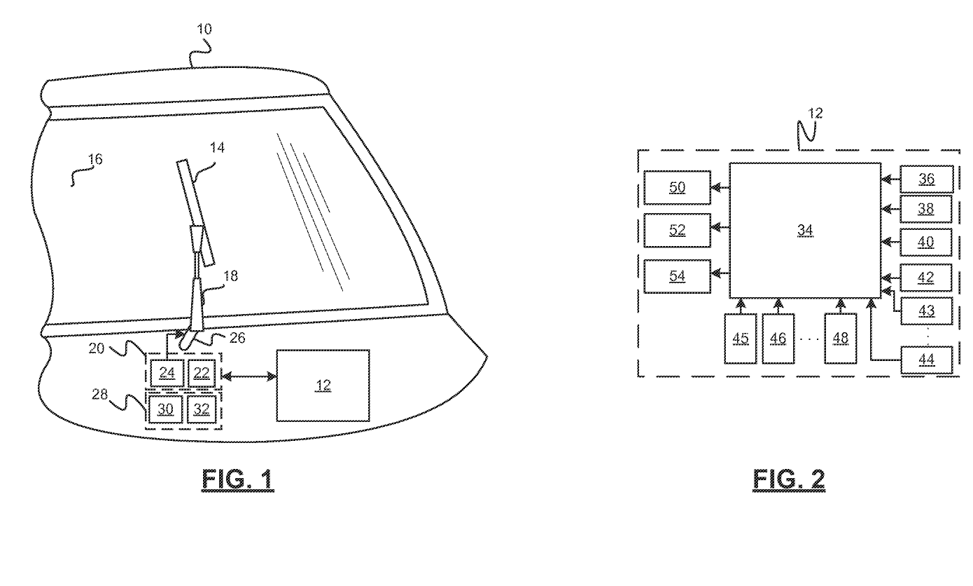

Referring now to FIG. 1, a vehicle 10 is shown to include a wiper blade monitoring system 12 that monitors the wiper blade 14, among other components, of the vehicle 10 in order to predict and notify a user of a use life of the wiper blade 14. Although the figures shown herein depict an example with certain arrangements of elements, additional intervening elements, devices, features, or components may be present in an actual embodiments. It should also be understood that FIG. 1 is merely illustrative and may not be drawn to scale.

As depicted in FIG. 1, the vehicle 10 generally includes one or more wiper blade 14 and a wiper blade monitoring system 12. As can be appreciated, the vehicle 10 may be any vehicle type including an automobile, an aircraft, a train, a watercraft, or any other vehicle type that includes a wiper blade 14. For exemplary purposes, the disclosure will be discussed in the context of the vehicle 10 being an automobile having a wiper blade 14 associated with a windshield 16 of the automobile.

As shown in FIG. 1, the wiper blade 14 detachably couples to a wiper arm 18. The wiper arm 18 pivotally couples to the vehicle 10. The pivotal movement of the wiper arm 18 is driven by a drive mechanism 20. The drive mechanism 20 generally includes a power source 22 and a drive motor 24. In operation, power is supplied from the power source 22 to the drive motor 24 and the drive motor 24 drives the pivotal movement of the wiper arm 18 (e.g., via a drive pilot and linkage mechanism 26, or other coupling devices (not shown)).

In various embodiments, a frequency or speed of the pivotal movement of the wiper arm 18 is controllable by a wiper blade control system 28. For example, the wiper blade control system includes a control module 30 that controls the drive motor 24 to vary the frequency or speed of the movement of the wiper arm 18. The wiper blade controls system further includes a user input device 32 (e.g., a switch or other device) that is able to be manipulated by a user to select the speed or frequency of the movement of the wiper arm 18. The control module 30 receives input from the user input device 32. In particular, the control module 30 controls the power supplied to the drive motor 24 based on the selection of the speed or frequency via the user input device 32.

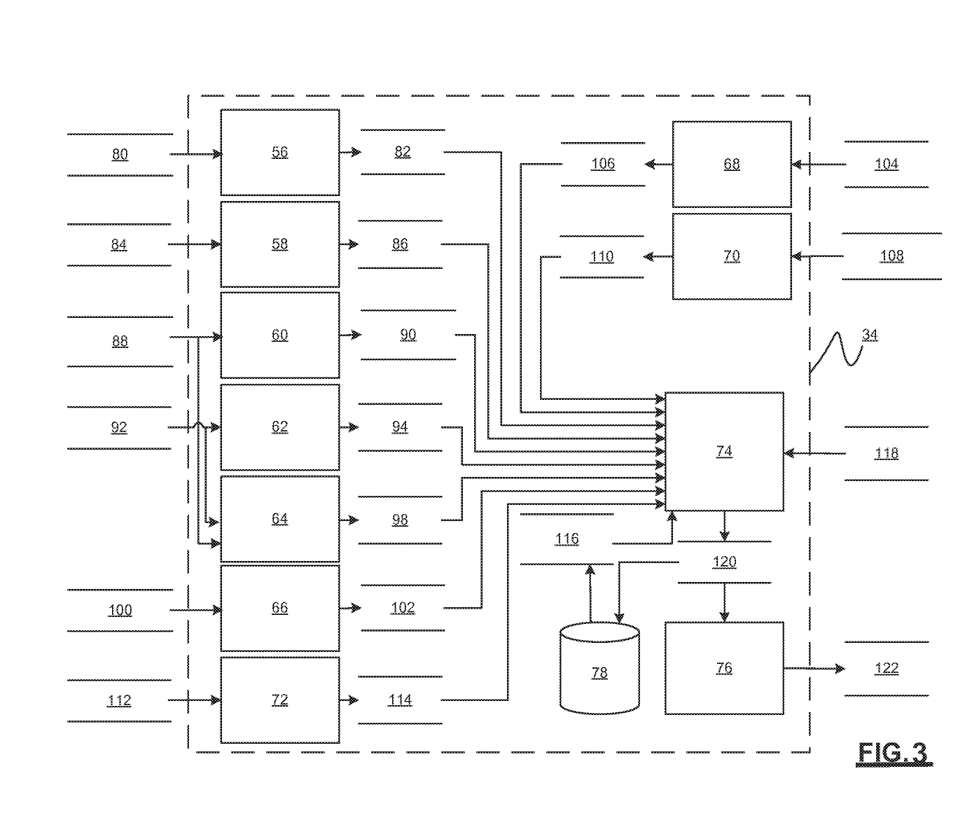

The wiper blade monitoring system 12 monitors conditions associated with the wiper blade 14 and to predict and notify a user of a use life of the wiper blade 14. With reference now to FIG. 2 and with continued reference to FIG. 1, the wiper blade monitoring system 12 generally includes a control module 34. The control module 34 may be integrated with the control module 30 of the wiper blade control system 28, or may be implemented as another module and may communicate with the control module 30 (as shown). The control module 34 is communicatively coupled to one or more sensors 36-44, and one or more information systems 44-48. The sensors 36-44 sense observable conditions of the wiper blade 14 and/or of the vehicle 10. For example, a sensor 36 is a humidity sensor that senses a humidity of the ambient air and that generates sensor signals based thereon. A sensor 38 is a light sensor that senses ambient light (e.g., ultraviolet or otherwise) and that generates sensor signals based thereon. A sensor 40 is a temperature sensor that senses an ambient temperature and that generates sensor signals based thereon. A sensor 42 is a motor voltage/current sensor that senses a voltage and/or a current of the drive motor 24 and that generates sensor signals based thereon. A sensor 43 is a proximity sensor that senses whether the wiper blade 14 is present and engaged and that generates sensor signals based thereon. A sensor 44 is an angle sensor that senses an angle of the wiper arm and that generates sensor signals based thereon.

The information systems 45-48 provide vehicle information to the control module 34 directly or indirectly through a communication bus (not shown). For example, a global positioning information system (GPS) 45 provides location information such as coordinates or region information. A vehicle calendar information system 46 provides calendar information such as a current date and/or a current time.

The control module 34 monitors the usage of the wiper blade 14 based on the received signals from the sensors 36-44 and/or the data from the information systems 44-48. The control module 34 determines a use life of the wiper blade 14 based on the received signals and data. The control module 34 generates notification data to notify a user of the use life of the wiper blade 14. The notification data is received by a display device 50, audio device 52, and/or a haptic device 54, and is used to issue notifications to the user. As can be appreciated, the notification can be any type of notification including an audio notification, a visual notification, and/or a haptic notification.

Referring now to FIG. 3 and with continued reference to FIGS. 1 and 2, a dataflow diagram illustrates various embodiments of the control module 34 in greater detail. Various embodiments of the control module 34 according to the present disclosure may include any number of sub-modules. As can be appreciated, the sub-modules shown in FIG. 2 may be combined and/or further partitioned to similarly monitor the wiper blade 14. Inputs to the control module 34 may be received from the sensors 36-44, received from the information systems 44-48, received from other control modules (not shown) of the vehicle 10, and/or determined by other sub-modules (not shown) of the control module 34. In various embodiments, the control module 34 includes a plurality of factor determination modules 56-70, a wiper presence sensing module 72, a usage calculation module 74, and a notification determination module 76.

The factor determination modules 56-70 each process data from sources that indicate a usage of the wiper blade 14 to determine an amount of the usage. The amount of usage for each may be presented as a use factor of an overall usage. In various embodiments, the use factor is a percent value indicating a percent of usage. In various embodiments, the factor determination modules include a humidity factor determination module 56, a light factor determination module 58, a temperature factor determination module 60, a wiper load factor determination module 62, a loss factor determination module 64, a wipe cycle factor determination module 66, a location factor determination module 68, and an age factor determination module 70.

The humidity factor determination module 56 receives as input humidity data 80. The humidity data 80 may be received from the humidity sensor 36. The humidity factor determination module 56 processes the humidity data 80 to determine a humidity factor 82. In various embodiments, the humidity factor 82 is a percentage. The percentage can be associated with a humidity level. For example, the higher the humidity level, the higher the percentage (i.e., indicating a greater effect on the wiper blade 14).

In various embodiments, the humidity levels and the associated percentages may be stored in a two-dimensional lookup table. In such embodiments, the humidity factor determination module 56 includes the lookup table and determines the humidity level based on the humidity data 80 (e.g., an average humidity over a time period) and uses the determined humidity level to retrieve the associated percentage from the lookup table. As can be appreciated, the lookup table may or may not be an interpolation table.

The light factor determination module 58 receives as input light data 84. The light data 84 may be received from the light sensor 38. The light factor determination module 58 processes the light data 84 to determine a light factor 86. In various embodiments, the light factor 86 is a percentage. The percentage can be associated with a light level. For example, the higher the light level, the higher the percentage (i.e., indicating a greater effect on the wiper blade 14).

In various embodiments, the light levels and the associated percentages may be stored in a two-dimensional lookup table. In such embodiments, the light factor determination module 58 includes the lookup table and determines the light level based on the light data 84 (e.g., an average light over a time period) and uses the determined light level to retrieve the associated percentage from the lookup table. As can be appreciated, the lookup table may or may not be an interpolation table.

The temperature factor determination module 60 receives as input temperature data 88. The temperature data 88 may be received from the temperature sensor 40. The temperature factor determination module 60 processes the temperature data 88 to determine a temperature factor 90. In various embodiments, the temperature factor 90 is a percentage. The percentage can be associated with a temperature level. For example, the higher the temperature level, the higher the percentage (i.e., indicating a greater effect on the wiper blade 14).

In various embodiments, the temperature levels and the associated percentages may be stored in a two-dimensional lookup table. In such embodiments, the temperature factor determination module 60 includes the lookup table and determines the temperature level based on the temperature data 88 (e.g., an average temperature over a time period) and uses the determined temperature level to retrieve the associated percentage from the lookup table. As can be appreciated, the lookup table may or may not be an interpolation table.

The wiper load factor determination module 62 receives as input motor voltage/current data 92. The motor voltage/current data 92 may be received from the voltage/current sensor 42. The wiper load factor determination module 62 processes the motor voltage/current data 92 to determine a load on the motor and thus the wiper blade 14. The wiper load factor determination module 62 processes the load to determine a load factor 94. In various embodiments, the load factor 94 is a percentage. The percentage can be associated with a load level. For example, the higher the load level, the higher the percentage (i.e., indicating a greater effect on the wiper blade 14).

In various embodiments, the load levels and the associated percentages may be stored in a two-dimensional lookup table. In such embodiments, the wiper load factor determination module 62 includes the lookup table and determines the load level based on the determined load (e.g., an average load over a time period) and uses the determined load level to retrieve the associated percentage from the lookup table. As can be appreciated, the lookup table may or may not be an interpolation table.

The loss factor determination module 64 receives as input the temperature data 88 and the motor voltage/current data 92. The loss factor determination module 64 processes the temperature data 88 and the motor voltage/current data 92 to determine a loss on the wiper blade 14 (e.g., low temperature and high voltage indicating conditions such as snow/ice blockage that can age the wiper blade 14). The loss factor determination module 64 processes the loss to determine a loss factor 98. In various embodiments, the loss factor 98 is a percentage. The percentage can be associated with a loss level. For example, the higher the loss level, the higher the percentage (i.e., indicating a greater effect on the wiper blade 14).

In various embodiments, the loss levels and the associated percentages may be stored in a two-dimensional lookup table. In such embodiments, the loss factor determination module 64 includes the lookup table and determines the loss level based on the determined loss (e.g., an average loss over a time period) and uses the determined loss level to retrieve the associated percentage from the lookup table. As can be appreciated, the lookup table may or may not be an interpolation table.

The wipe cycle factor determination module 66 receives as input wiper data 100. The wiper data 100 may be received from the control module 30 that controls the wiper blade 14. The wiper data 100 indicates a time of use of the wiper blade 14 and a speed associated with the time or simply a wiper count indicating a count of swipes in a particular time period. The wipe cycle factor determination module 66 processes the wiper data 100 to determine a number of wipe cycles or a usage of the wiper blade 14. The wipe cycle factor determination module 66 processes the number of wipe cycles or usage of the wiper blade 14 to determine a wipe cycle factor 102. In various embodiments, the wipe cycle factor 102 is a percentage. The percentage can be associated with a wipe cycle level. For example, the higher the wipe cycle level, the higher the percentage (i.e., indicating a greater effect on the wiper blade 14).

In various embodiments, the wipe cycle levels and the associated percentages may be stored in a two-dimensional lookup table. In such embodiments, the wipe cycle factor determination module 66 includes the lookup table and determines the wipe cycle level based on the determined wipe cycle (e.g., an average wipe cycle over a time period) and uses the determined wipe cycle level to retrieve the associated percentage from the lookup table. As can be appreciated, the lookup table may or may not be an interpolation table.

The location factor determination module 68 receives as input location data 104. The location data 104 may indicate an exact location or a region and be received from the GPS system 44. The location factor determination module 68 processes the location data 104 to determine a location factor 106. In various embodiments, the location factor 106 is a percentage. The percentage can be associated with a location or region.

In various embodiments, the locations or regions and the associated percentages may be stored in a two-dimensional lookup table. In such embodiments, the location factor determination module 68 includes the lookup table and determines the location or region (e.g., a most frequent location over a time period) and uses the determined location or region to retrieve the associated percentage from the lookup table. As can be appreciated, the lookup table may or may not be an interpolation table.

The age factor determination module 70 receives as input vehicle calendar data 108. The vehicle calendar data 108 may indicate a date, time, and/or month and may be received from the vehicle calendar information system 46. The age factor determination module 70 processes the vehicle calendar data 108 to determine an age factor 110. In various embodiments, the age factor 110 is a percentage. The percentage can be associated with an age.

In various embodiments, the ages and the associated percentages may be stored in a two-dimensional lookup table. In such embodiments, the age factor determination module 70 includes the lookup table and determines the age (e.g., as a difference from a first use date and the current date) and uses the determined location or region to retrieve the associated percentage from the lookup table. As can be appreciated, the lookup table may or may not be an interpolation table.

The wiper presence sensing module 72 receives as input wiper presence data 112. The wiper presence data 112 may be received from the sensors 43, 44 and indicates a presence and/or angle of the wiper blade 14. The wiper presence sensing module 72 evaluates the wiper presence data 112 to determine a presence status 114. For example, if the presence data 112 indicates the wiper is present, engaged and/or the wiper arm angle is within a range, the wiper presence sensing module 72 sets the presence status to TRUE. If, however, the presence data 112 indicates the wiper is not present, is not engaged, and/or is not within the predefined range, the wiper presence sensing module sets the presence status to FALSE.

The usage calculation module 74 receives as input the factors from each of the factor determination modules 56-70 and the presence status 114. As shown, the usage calculation module 74 receives the humidity factor 82, the light factor 86, the temperature factor 90, the load factor 94, the loss factor 98, the wipe cycle factor 102, the location factor 106, and the age factor 110. The usage calculation module 74 computes a use life based on the factors. For example, the usage calculation module 74 computes a summation of receives the humidity factor 82, the light factor 86, the temperature factor 90, the load factor 94, the loss factor 98, the wipe cycle factor 102, the location factor 106, and the age factor 110. The summation is an indication of the current usage. The usage calculation module 74 computes a use life 120 by applying the current usage to a previous usage. For example, the usage calculation module 74 adds the sum to a previously stored use life 116. The previously stored use life 116 may be stored in and retrieved from the use life datastore 78.

In various embodiments, the usage calculation module 74 computes the use life 120 based on the presence status 114. For example, when the presence status 114 indicates FALSE (i.e., that the wiper blade is not present or engaged, or that the wiper arm angle is not within a range), the usage calculation module 74 sets the use life 120 to 100 percent. In another example, when the presence status 114 indicates TRUE, the usage calculation module 74 computes the use life 120 as discussed above.

In various embodiments, the usage calculation module 74 receives as input a reset status 118. The reset status 118 may indicate whether or not to reset the use life. The reset status 118 may be generated based on a user interacting with a reset user input device and/or may be generated automatically based on a determination that the wiper blade 14 has been changed. When the reset status 118 indicates to reset the use life (e.g., TRUE or other value), the usage calculation module 74 stores a default value (e.g., zero percent, or other value) in the use life datastore 78. When the reset status 118 indicates not to reset the use life (e.g., FALSE or other value), the newly computed use life 120 is stored in the use life datastore 78 for future computations.

The notification determination module 76 receives as input the computed use life 120. The notification determination module 76 generates notification data 122 to notify the user based on the use life 120. In various embodiments, the notification determination module 76 generates the notification data 122 when the use life 120 indicates that the life of the wiper blade 14 is near complete (e.g., when the use life 120 is greater than a threshold). The notification data 122 includes a message or other indication (e.g., audio or haptic) that the life of the wiper blade 14 is near complete or that it is time to change the wiper blade 14. In various embodiments, the notification determination module 76 generates the notification data 122 based on the use life 120. The notification data 122 includes a message or other indication of the value of the use life 120.

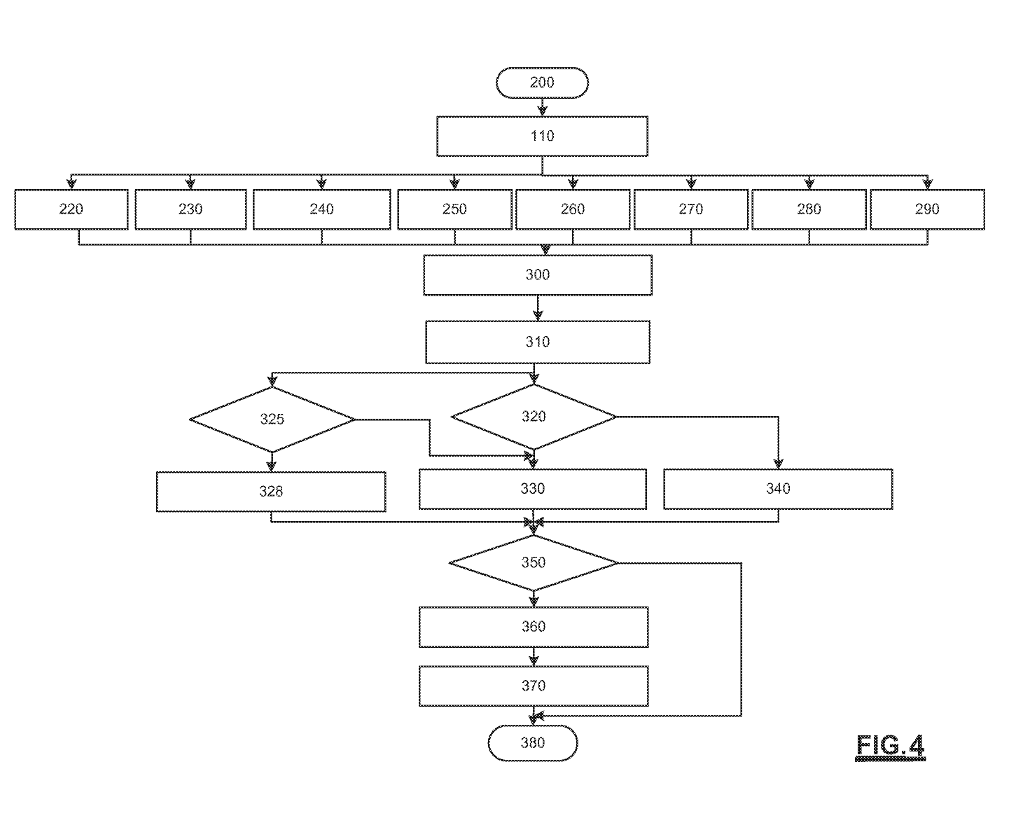

Referring now to FIG. 4, and with continued reference to FIGS. 1-3, a flowchart illustrates a control method that can be performed by the wiper blade monitoring system 12 in accordance with various embodiments. As can be appreciated in light of the disclosure, the order of operation within the method is not limited to the sequential execution as illustrated in FIG. 4, but may be performed in one or more varying orders as applicable and in accordance with the present disclosure.

As can further be appreciated, the method of FIG. 4 may be scheduled to run at predetermined time intervals during operation of the vehicle 10 and/or may be scheduled to run based on predetermined events.

In one example, the method may begin at 200. The sensor data and/or information system data is received at 110. The use factors are determined at 220-290 based on the sensor data and/or other information data. For example, the humidity factor 82 is determined at 220. The light factor 86 is determined at 230. The temperature factor 90 is determined at 240. The load factor 94 is determined at 250. The wipe cycle factor 102 is determined at 260. The loss factor 98 is determined at 270. The location factor 106 is determined at 280. The age factor 110 is determined at 290. As can be appreciated, other factors not shown may be determined in various embodiments.

The summation of the use factors is computed at 300. The computed summation is added to the previously stored use life 116 at 310. It is determined whether the reset status 118 indicates to reset the use life at 320. If the reset status 118 indicates to reset the use life at 320, the default value is stored as the computed use life 120 at 340. If, however, the reset status indicates not to reset the use life at 320, the newly computed use life is stored as the use life 120 in the use life datastore 78 at 330. The use life 120 is evaluated at 350. The presence status 114 is determined and evaluated at 325. If the presence status is determined to be FALSE, the default value of 100 percent is stored as the computed use life 120 at 328. If, however, the presence status 114 is determined to be TRUE, the newly computed use life is stored as the use life 120 in the use life datastore 78 at 330.

If the stored use life 120 is less than a limit threshold at 350, the method may end with no notification at 380. If, however, the stored use life 120 is greater than the limit threshold at 350, the notification data 122 is generated at 360 and the user is notified based on the notification data 122 at 370. Thereafter, the method may end at 380.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of monitoring a wiper blade, the method comprising:
determining at least one use factor;
computing a use life based on the at least one use factor; and
selectively generating notification data based on the use life.

2. The method of claim 1, further comprising determining a plurality of use factors, and wherein the computing the use life is based on the plurality of use factors.

3. The method of claim 2, wherein the computing the use life is based on a summation of the plurality of use factors.

4. The method of claim 1, wherein the computing the use life is based on the at least one use factor and a previous use life.

5. The method of claim 5, wherein the computing the use life is based on a summation of the at least one use factor and the previous use life.

6. The method of claim 1, wherein the at least one use factor is a humidity factor.

7. The method of claim 1, wherein the at least one use factor is a light factor.

8. The method of claim 1, wherein the at least one use factor is a temperature factor.

9. The method of claim 1, wherein the at least one use factor is a load factor.

10. The method of claim 1, wherein the at least one use factor is a loss factor.

11. The method of claim 1, wherein the at least one use factor is a wipe cycle factor.

12. The method of claim 1, wherein the at least one use factor is a location factor.

13. The method of claim 1, wherein the at least one use factor is an age factor.

14. The method of claim 1, wherein the notification data includes a value of the use life.

15. The method of claim 1, wherein the notification data indicates that a life of the wiper blade is near complete.

16. The method of claim 1, wherein the notification data indicates that it is time to change the wiper blade.

17. The method of claim 1, wherein the notification data includes at least one of display data, haptic data, and audio data.

18. A vehicle, comprising:
a wiper blade; and
a control module that determines at least one use factor, that computes a use life based on the at least one use factor, and that selectively generates notification data based on the use life.

19. The vehicle of claim 18, wherein the control module computes the use life based on a summation of a plurality of use factors.

20. The method of claim 18, wherein the at least one use factor is at least one of a humidity factor, a light factor, a temperature factor, a load factor, a loss factor, a wipe cycle factor, a location factor, and an age factor.
